(19) United States
(12) Patent Application Publication
(10) Pub. No.: US 2017/0276248 A1
(43) Pub. Date: Sep. 28, 2017

(54) SEAL BODY AND GAS SEAL MECHANISM

(71) Applicant: TOYOTA JIDOSHA KABUSHIKI KAISHA, Toyota-shi (JP)

(72) Inventors: Chihiro UCHIMURA, Toyota-shi (JP); Sogo GOTO, Miyoshi-shi (JP); Akira YAMASHITA, Toyota-shi (JP); Shusuke INAGI, Okazaki-shi (JP)

(73) Assignee: TOYOTA JIDOSHA KABUSHIKI KAISHA, Toyota-shi (JP)

(21) Appl. No.: 15/618,556

(22) Filed: Jun. 9, 2017

Related U.S. Application Data
(62) Division of application No. 14/301,829, filed on Jun. 11, 2014.

(30) Foreign Application Priority Data
Jun. 13, 2013 (JP) 2013-124379

(51) Int. Cl. F16J 15/06; F16J 15/3236; F16J 15/16

(52) U.S. Cl. CPC F16J 15/06; F16J 15/164; F16J 15/3236

(57) ABSTRACT

A seal body that is used for gas seal includes a seal main body in which a recessed groove is formed by arranging a pair of lips so that the lips face each other; an elastic body that is inserted in the recessed groove and expands the lips; and a rigid body that is installed in the elastic body, and restricts deformation of the elastic body, due to narrowing of the recessed groove, within an elastic deformation range.

### INCORPORATION BY REFERENCE

The disclosure of Japanese Patent Application No. 2013-124379 filed on Jun. 13, 2013 including the specification, drawings and abstract is incorporated herein by reference in its entirety.

### BACK GROUND OF THE INVENTION

1. Field of the Invention

The present invention relates to a seal body and a gas seal mechanism.

2. Description of Related Art

A seal body, in which a U-shaped seal serves as a seal main body, is able to exert high sealing performance by concurrently using a spring that expands lips. Thus, the seal body is employed as a hermetic seal for a flow passage of high-pressure gas such as high-pressure hydrogen gas in a fuel cell power generation system, a fuel cell mounting vehicle, and so on (for example, Japanese Patent Application Publication No. 2004-76870 (JP 2004-76870 A)).

In a case where a seal body, which concurrently uses a spring, is incorporated in a gas flow passage for gas sealing, a gas flow passage on one side of the seal body has higher pressure than that of the gas flow passage on the other side. For example, in a case where a seal body is used to seal a gas flow passage that is connected with a main flow passage extending from a high-pressure hydrogen gas tank, storing hydrogen gas at high pressure, to a fuel cell, a gas flow passage on the main gas flow passage side has higher gas pressure, and the gas flow passage on the other side of the seal body has lower gas pressure. Normally, the levels of gas pressure in the gas flow passages on both sides of the seal body do not change. Therefore, there is no particular difficulty in maintaining sealability. However, when gas stored in a tank is consumed until a gas residual amount becomes almost zero, or gas is flown into the gas flow passage at low gas pressure from the other flow passage, inversion of the levels of gas pressure of the gas flow passages on both sides of the seal body, i.e., back pressure, happens at least temporarily. In a case where a seal body is used to seal a flow passage that connects main gas flow passages extending from a plurality of high-pressure gas tanks, respectively, it is possible that the main gas flow passage from the high-pressure gas tank, which is used to be on a high pressure side, may have lower pressure than that of the main gas flow passage from the other high-pressure gas tank, due to consumption of gas. Shortly after occurrence of the back pressure, the levels of gas pressure in the gas flow passages on both sides of the seal body return to original pressure states, i.e., forward pressure. However, in the viewpoint of reproduction of sealability when forward pressure is recovered, a sort of measure is now required when back pressure happens. It is also demanded to reduce a size and costs of a seal body that is able to deal with back pressure, or simplify and reduce costs of a structure of a gas seal mechanism in which the seal body is used.

### SUMMARY OF THE INVENTION

A first aspect of the invention relates to a seal body that is used for gas seal. The seal body includes a seal main body in which a recessed groove is formed by arranging a pair of lips so that the lips face each other, an elastic body that is inserted in the recessed groove and expands the lips, and a rigid body that is installed in the elastic body and restricts deformation of the elastic body, due to narrowing of the recessed groove, within an elastic deformation range. When inversion of levels of gas pressure in gas flow passages on both sides of the seal body, i.e., back pressure, happens, the recessed groove is narrowed due to the back pressure, and the elastic body is deformed due to the narrowing of the recessed groove. Even in this case, in the seal body, the rigid body restricts the deformation within the elastic deformation range, and does not allow plastic deformation of the elastic body. Therefore, when the back pressure subsides, and the levels of the gas pressure of the gas flow passages on both sides of the seal body return to an original pressure state, i.e., forward pressure, the elastic body returns to a previous state before the back pressure happened. Therefore, according to the seal body, even if back pressure happens, once the back pressure subsides, original sealability is reproduced without any problem and the seal body is used continuously when forward pressure is recovered. Therefore, it is possible to improve continuity of sealing and seal durability. The rigid body is only installed in the elastic body, and is not related to expansion of the lips by the elastic body. Therefore, according to the seal body of this form, a size of the seal body can be similar to that of an existing seal body, and may thus be made compact.

The rigid body may have a slit. This way, in installing the rigid body in the elastic body, the slit splits linkage of the rigid body, which gives a higher degree of deformational freedom of the rigid body. Therefore, mountability and installability of the rigid body on the elastic body are enhanced, and costs including assembly costs are reduced.

The elastic body may be a metallic spring, and the rigid body may be installed inside the spring. This way, an existing seal body having no rigid body may be used easily, and versatility is increased. At the same time, the rigid body is inserted inside the spring easily. By using the metallic spring, sufficient elastic force is given to the seal body.

A second aspect of the invention relates to a gas seal mechanism that achieves gas seal in a gas flow passage formed by a housing. The gas seal mechanism includes a shaft body incorporated in the gas flow passage, and a seal body stored in a seal body storing region between the shaft body and the housing. The seal body includes a seal main body in which a recessed groove is formed by arranging a pair of lips so that the lips face each other, an elastic body that is inserted in the recessed groove and expands the lips, and a rigid body that is installed in the elastic body and restricts deformation of the elastic body, due to narrowing of the recessed groove, within an elastic deformation range. The seal body is stored in the seal body storing region so that an opening side of the recessed groove is located on a high pressure side of the seal body in the gas flow passage. According to the gas seal mechanism, even if inversion of levels of gas pressure in the gas flow passages on both sides of the seal body, i.e., back pressure, happens, once the back pressure subsides, original sealability is reproduced without any problem and the gas seal mechanism is used continuously, and continuity of sealing and seal durability are improved.

The invention may be realized in various forms. For example, in addition to various types of valve mechanisms incorporated in gas flow passages, the invention is applicable to a vehicle including a high-pressure gas tank and a gas consumption apparatus such as a fuel cell, and a gas flow passage that connects the apparatuses. The invention may also be applicable to a power generation plant including a fuel cell and a high-pressure gas tank that are installed in factories, stores, or houses.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory view showing a section of a schematic structure of a gas seal mechanism as an embodiment of the invention;

FIG. 2 is an explanatory view showing a plan view and a sectional view of a rigid ring of a seal body included in the gas seal mechanism;

FIG. 3A and FIG. 3B are explanatory views explaining effects of the gas seal mechanism according to the embodiment together with a behavior of the seal body;

FIG. 4A and FIG. 4B are explanatory views showing behavior of an existing seal body in an existing gas seal mechanism in which the rigid ring is not provided;

FIG. 5 is an explanatory view showing a plan view and a sectional view of a rigid ring according to another embodiment;

FIG. 6A and FIG. 6B are sectional views of a seal body according to yet another embodiment, explaining behavior or the seal body in a forward pressure sealing condition and a back pressure sealing condition; and

FIG. 7 is an explanatory view showing a section of a schematic structure of a gas seal mechanism according to another embodiment.

### DETAILED DESCRIPTION OF EMBODIMENTS

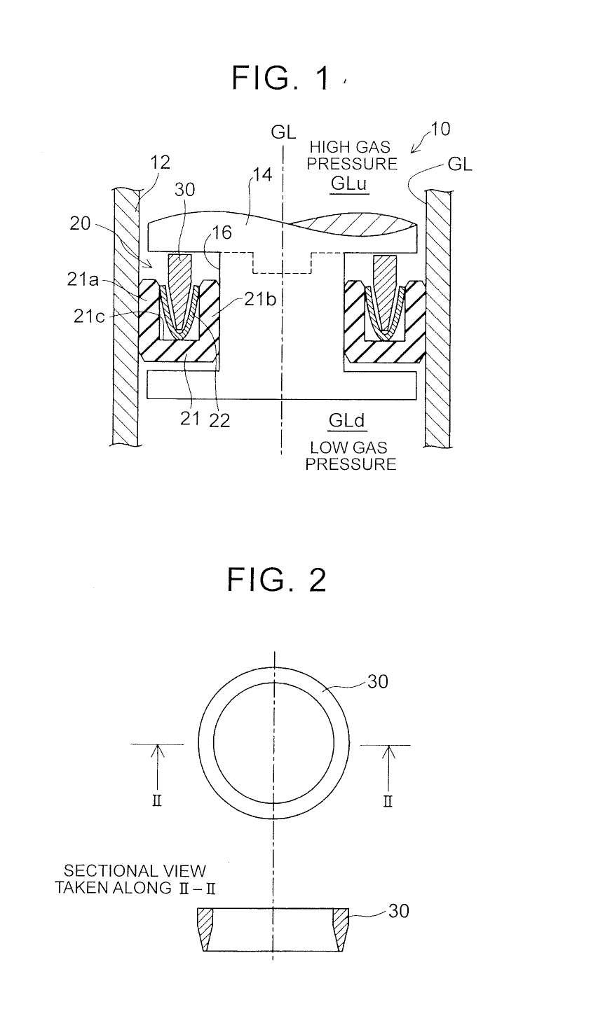

Embodiments of the invention are explained below based on the drawings. FIG. 1 is an explanatory view showing a section of a schematic structure of a gas seal mechanism 10 as an embodiment of the invention, and FIG. 2 is an explanatory view showing a plan view and sectional view of a rigid ring 30 of a seal body 20 included in the gas seal mechanism 10.

As shown in FIG. 1 and FIG. 2, the gas seal mechanism 10 includes a shaft body 14 and the seal body 20 in order to achieve gas seal in a gas flow passage GL formed by a housing 12. The shaft body 14 is incorporated in the gas flow passage GL and has a seal body storing region 16 on an outer peripheral wall of the shaft body 14. The seal body storing region 16 is formed into a recessed shape around an outer periphery of the shaft body 14, stores the later-described seal body 20 with some room in an axis direction of the shaft body, and receives the later-described rigid ring 30 on a ceiling wall in FIG. 1 so as to avoid falling of the seal body 20 from the seal body storing region 16. The ceiling wall of the seal body storing region 16 may be formed by fitting or screw fastening of the ceiling wall to an upper shaft part of the shaft body 14 in FIG. 1. This way, installation of the later-described seal body 20 becomes simple and easy.

The seal body 20 includes a ring-like seal main body 21, a spring 22, and the rigid ring 30. The seal main body 21 is a resin product with resistance to gas to be sealed. For example, when the gas seal mechanism 10 is applied to seal high-pressure hydrogen gas, the seal body 20 is made of a resin such as polytetrafluoroethylene (PTFE) and high-density polyethylene to have elastic force, and forms a recessed groove 21c by arranging a pair of lips 21a, 21b so that the lips 21a, 21b face each other. The seal main body 21 may be an existing U-shaped seal made of PTFE.

The spring 22 is a molded product obtained by molding a steel spring plate into a circular body with a V-shaped section, and elastically rebounds in a direction in which an opening end of the V-shaped section expands when the opening end is narrowed. The spring 22 is inserted in the recessed groove 21c of the seal main body 21, expands the lip 21a and the lip 21b by the elastic force, and presses the lip 21a and the lip 21b against an inner peripheral wall of the housing 12 and an inner peripheral wall of the seal body storing region 16. Because the lips are pressed, the seal body 20 achieves gas seal of the gas flow passage GL.

As shown in FIG. 2, the rigid ring 30 has a circular shape, and a lower end side of the rigid ring 30 in FIG. 2 is tapered. The rigid ring 30 is installed inside the spring 22 so that the tapered lower end side comes to the bottom of the spring 22 and that the tapered surfaces face an inner surface of the spring 22. In this case, the rigid ring 30 is formed so that the sectional shape of the rigid ring 30 does not interfere with the spring 22 that causes expansion of the lips. In addition, the rigid ring 30 is formed so that the rigid ring 30 supports the inner surface of the spring 22 and restricts deformation of the spring 22 within an elastic deformation range, when the spring 22 is compressed so as to narrow an opening end of the spring 22. Specifically, the tapered area of the rigid ring 30 has a predetermined thickness so as to be able to support the inner surface the compressed spring 22 and restrict deformation of the spring 22 within the elastic deformation range. The rigid ring 30 only needs to be resistant to compression force when the spring 22 is compressed as stated above, and may thus be a molded product made of metal, a lightweight alloy, or a high-strength resin.

The seal body 20 structured as above is stored in the seal body storing region 16 of the shaft body 14. Thus, the seal body 20 seals the gas flow passage GL and divides the gas flow passage GL into an upstream side gas flow passage GLu and a downstream side gas flow passage GLd in FIG. 1 across the seal body 20. The gas seal mechanism 10 according to this embodiment seals the gas flow passage GL assuming that the upstream side gas flow passage GLu is a high gas pressure side and the downstream side gas flow passage GLd is a low gas pressure side. A sealing condition under the above-mentioned gas pressure state is referred to as a forward pressure sealing condition. In the forward pressure sealing condition, the seal body 20 is arranged so that the opening side of the recessed groove 21c is located on the side of the upstream side gas flow passage GLu, which is the gas flow passage GL on the higher pressure side of the seal body 20.

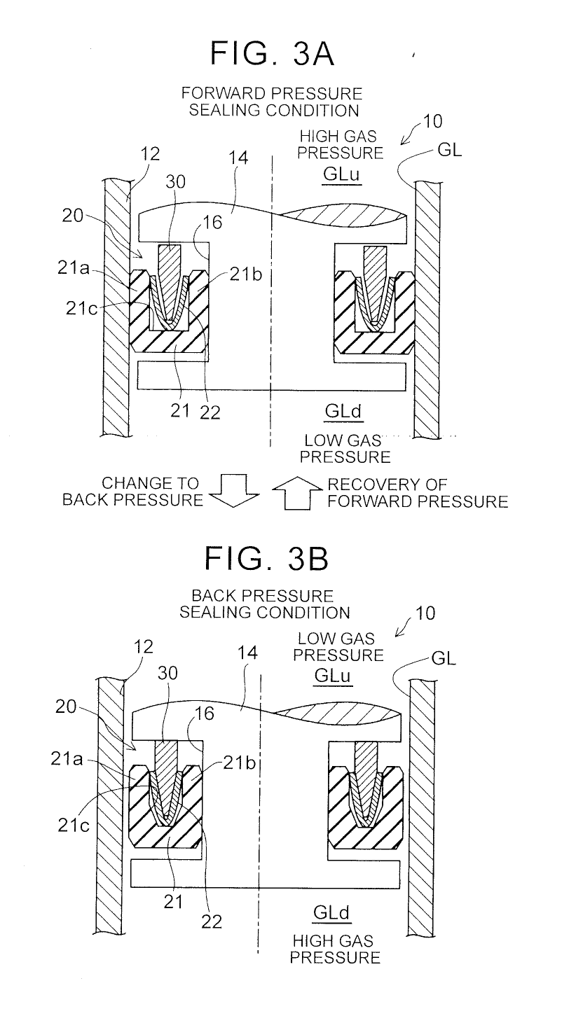

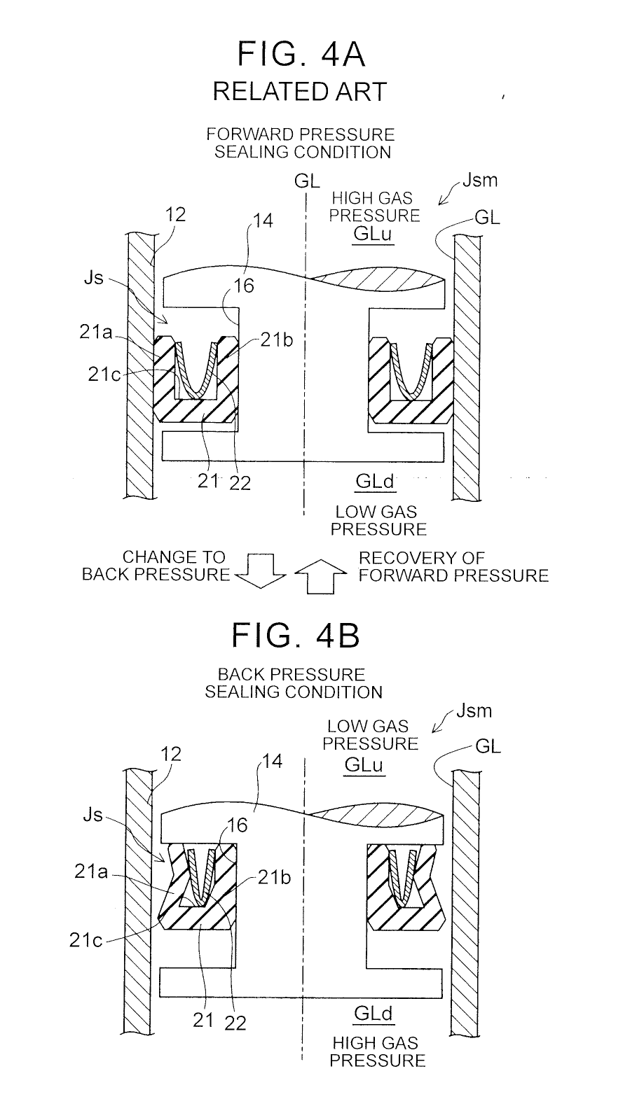

The gas seal mechanism 10 according to this embodiment having the above-explained structure has the following advantages. FIG. 3A and FIG. 3B are explanatory views explaining effects of the gas seal mechanism 10 according to the embodiment together with a behavior of the seal body 20, and FIG. 4A and FIG. 4B are explanatory views showing behavior of an existing seal body Js in an existing gas seal mechanism Jsm in which the rigid ring 30 is not provided.

When the gas seal mechanism 10 seals the gas flow passage GL in the forward pressure sealing condition shown in FIG. 3A, back pressure may happen for some reasons. In other words, gas pressure of the downstream side gas flow passage GLd may become higher than that of the upstream side gas flow passage GLu. The sealing condition when the back pressure happens is referred to as a back pressure sealing condition. FIG. 3B shows behavior of the seal body 20 in the back pressure sealing condition. The recessed groove 21c is narrowed as the lip 21a receives force induced by a pressure difference that caused the back pressure. The spring 22 also receives the force induced by the pressure difference through the lip 21a and has compression deformation as the recessed groove 21c is narrowed. Even if the spring 22 has compression deformation, the spring 22 having the compression deformation is received by the rigid ring 30 that is already installed in the spring. Therefore, the compression deformation of the spring 22 is retained within the elastic deformation range by the rigid ring 30, and plastic deformation of the spring 22 does not happen.

Once a factor that caused the back pressure is removed and the back pressure subsides, the gas pressure in the upstream side gas flow passage GLu becomes higher than that of the downstream side gas flow passage GLd, and the forward pressure is recovered. Because of the recovery of the forward pressure, the spring 22 elastically rebounds and returns to a state before the back pressure happened, and sealing by the seal body 20 returns to the forward pressure sealing condition shown in FIG. 3A. At this time, although the spring 22 has had compression deformation due to the back pressure, the spring 22 is deformed within the elastic deformation range only. Thus, no plastic deformation occurred. Therefore, the spring 22 expands the lip 21a and the lip 21b similarly to the state before the back pressure happened. Hence, according to the gas seal mechanism 10 having the seal body 20 of this embodiment, when the forward pressure is recovered after the back pressure happens, original sealability is reproduced without any difficulty, and the seal body 20 and the gas seal mechanism 10 are used continuously. Thus, continuity of sealing and seal durability are improved.

On the other hand, in the existing gas seal mechanism Jsm, when back pressure happens so that a forward pressure sealing condition shown in FIG. 4A is changed to a back pressure sealing condition shown in FIG. 4B, a recessed groove 21c is narrowed, and compression deformation of a spring 22 happens due to the narrowing, similarly to this embodiment. In the existing gas seal mechanism Jsm, the spring 22 included in the existing seal body Js is deformed (has compression deformation) beyond an elastic deformation range, and could have plastic deformation. In this case, when the forward pressure is recovered after the back pressure subsides, the spring 22 is not able to rebound elastically to the previous condition before the back pressure happened, and is thus not able to expand a lip 21a and a lip 21b sufficiently. Therefore, in the existing gas seal mechanism Jsm having the existing seal body Js, it is not possible to reproduce original sealability when the forward pressure is recovered after back pressure happened, thereby making the sealing less reliable.

A test for recovering sealability was conducted on the gas seal mechanism 10 according to this embodiment shown in FIG. 3A and FIG. 3B and the existing gas seal mechanism Jsm shown in FIG. 4A and FIG. 4B. First of all, both of the gas seal mechanisms were put under the forward pressure sealing condition at 70 MPa (pressure on the upstream side in a normal condition), and then a back pressure sealing condition at 70 MPa, in which levels of pressure on an upstream side and the downstream side were inversed. Thereafter, quality of sealability was measured when the forward pressure sealing condition at 70 MPa was recovered. As a result, in the gas seal mechanism 10, in which plastic deformation of the spring 22 does not occur, good sealability was reproduced. On the other hand, in the existing gas seal mechanism Jsm, gas leakage was observed. The reason is assumed that sealability was not reproduced in the existing gas seal mechanism Jsm due to plastic deformation of the spring 22.

In the seal body 20 according to this embodiment, it is only necessary to install the rigid ring 30 inside the spring 22, and the rigid ring 30 is not related to expansion of the spring 22 and both of the lips 21a, 21b. Therefore, according to the seal body 20 of this embodiment, a size of the seal body may be similar to that of the existing seal body Js, and may thus be made compact. The seal body 20 according to this embodiment may be replaced with the existing seal body Js easily, and thus has high versatility. Therefore, by using the metallic spring 22, sufficient elastic force is given to the seal body 20.

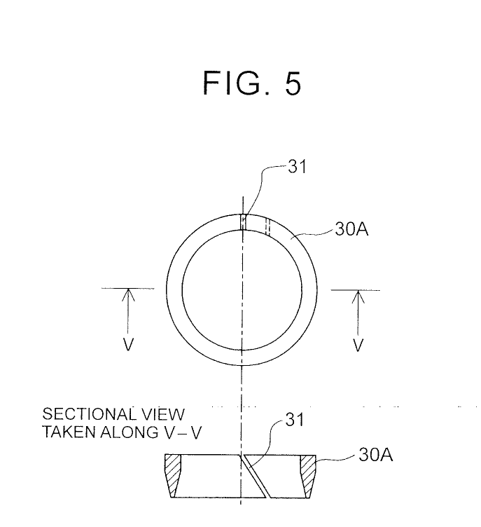

Next, a second embodiment is explained. FIG. 5 is an explanatory view showing a plan view and a sectional view of a rigid ring 30A according to another embodiment. As shown in FIG. 5, the rigid ring 30A has a slit 31 in a side wall. Therefore, when the rigid ring 30A is installed inside a spring 22, a degree of freedom for shape change is increased by the slit 31. As a result, mountability and installability of the rigid ring 30A inside the spring 22 are increased, and costs including assembly costs are reduced.

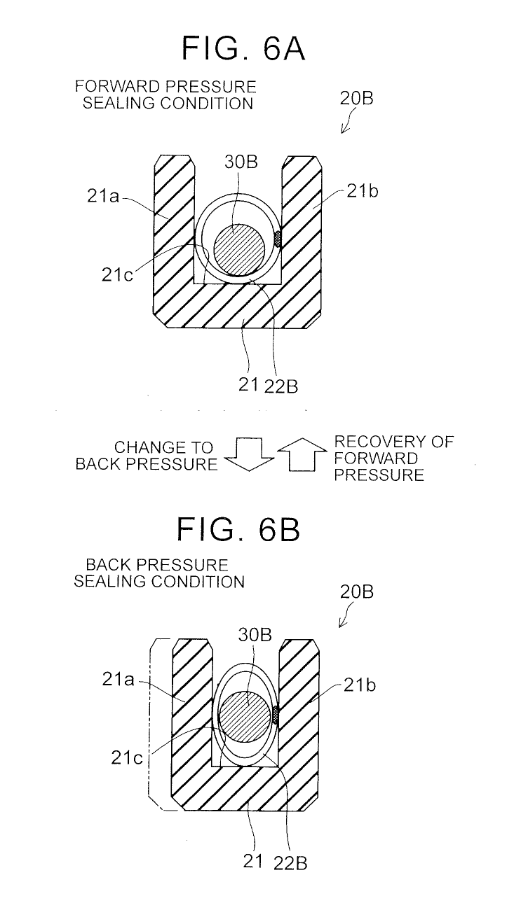

FIG. 6A and FIG. 6B are sectional views of a seal body 20B according to a third embodiment, explaining behavior of the seal body 20B in a forward pressure sealing condition and a back pressure sealing condition. As shown in FIG. 6A and FIG. 6B, the seal body 20B includes a seal main body 21, a spring 22B, and a rigid ring 30B, similarly to the seal body 20 according to the foregoing embodiment. In the seal main body 21, the spring 22B, which is a circular-shaped coil spring, is inserted and stored in a recessed groove 21c formed by a lip 21a and a lip 21b. In short, by fitting and inserting the coil spring having a given length inside the recessed groove 21c, the spring 22B has a circular shape and is stored in the recessed groove 21c. The rigid ring 30B is a bar-shaped body having a circular section. This bar-shaped body having a given length is inserted into the spring 22B, made of a coil spring, from an appropriate location. Thus, the rigid ring 30B is installed inside the spring 22B. As shown in a back pressure sealing condition in FIG. 6B, the rigid ring 30B restricts deformation of the spring 22B within an elastic deformation range when the spring 22B has compression deformation so that the circular coil shape of the spring 22B is crushed into an elliptical shape as the recessed groove 21c is narrowed. In short, the rigid ring 30B has a diameter that restricts the above-mentioned deformation of the spring 22B, due to narrowing of the recessed groove 21c, within the elastic deformation range. With the seal body 20B according to this embodiment, compression deformation of the spring 22B due to back pressure is retained within the elastic deformation range, and plastic deformation of the spring 22B is not allowed to happen. Therefore, salability is reproduced without any difficulty when forward pressure is recovered after back pressure happened, and the seal body 20B is used continuously, thereby improving continuity of sealing and seal durability.

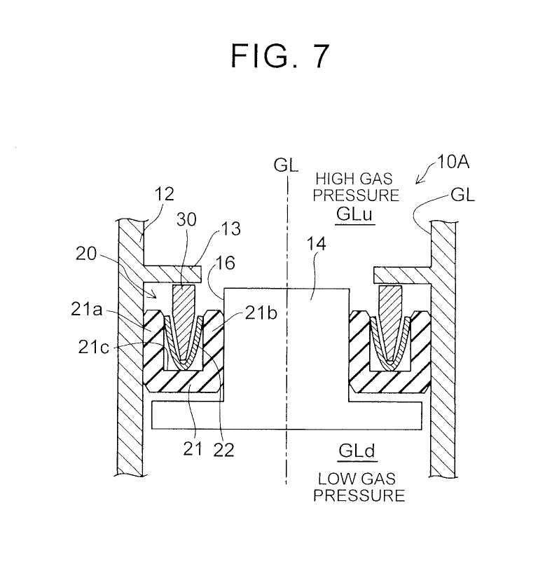

FIG. 7 is an explanatory view showing a section of a schematic structure of a gas seal mechanism 10A according to a fourth embodiment. As shown in FIG. 7, in the gas seal mechanism 10A, a shaft body 14 is a projected body, and a step part of the shaft body 14 serves as a seal body storing region 16 for a seal body 20. The gas seal mechanism 10A also includes a flange part 13 on an inner peripheral wall of the housing 12, and the flange part 13 serves as a ceiling wall of the seal body storing region 16. According to the gas seal mechanism 10A of this embodiment, plastic deformation of a spring 22 is not allowed even if back pressure occurs. Therefore, the foregoing effects are obtained. In addition, since it is only necessary to install the seal body 20 in the step part of the shaft body 14, installability of the seal body 20 is improved.

The invention is not limited to the foregoing embodiments, and may be realized in various structures without departing from the gist of the invention. For example, the technical features of the embodiments may be replaced or combined as appropriate in order to solve a part of or all of the problems stated earlier, or to achieve a part of or all of the foregoing effects. The technical features may be removed as appropriate unless the features are explained as mandatory in this specification.

In the foregoing embodiments, the seal body storing region 16 is formed on the outer peripheral wall of the shaft body 14, but may also be formed on the inner peripheral wall of the housing 12. In this case, the housing 12 shown in FIG. 1 only needs to have a sufficient thickness to form the seal body storing region 16.

In the foregoing embodiments, the spring 22, which is made by molding steel spring plate into a circular body having a V-shaped section, and the spring 22B, which is a circular-shaped coil spring, are inserted and stored in the recessed groove 21c. However, any elastic body, which generates elastic force and expands a pair of lips by using the elastic force, may be used instead of the springs.

1. A gas seal mechanism that achieves gas seal in a gas flow passage formed by a housing, comprising:
a shaft body incorporated in the gas flow passage;
a seal body adapted for gas seal comprising:
a seal main body in which a recessed groove is formed by arranging a pair of lips so that the lips face each other;
a coil spring that is inserted in the recessed groove and expands the lips; and
a rigid body that is installed in the coil spring, and restricts deformation of the coil spring, due to narrowing of the recessed groove, within an elastic deformation range,
wherein the rigid body is a bar-shaped body having a given length and a circular section,
wherein the seal body being stored in a seal body storing region formed on an outer peripheral wall of the shaft body so as to be between the shaft body and the housing,
wherein the seal body is stored in the seal body storing region so that an opening side of the recessed groove is located on a high pressure side of the seal body in the gas flow passage, and
wherein the seal body storing region is a recess provided on the outer peripheral wall of the shaft body.

2. (canceled)

3. The seal body according to claim 1, wherein the elastic body is a metallic spring.

4. (canceled)

5. The seal body according to claim 1, wherein the seal main body and the elastic body have a ring shape.

6. (canceled)
